(19) United States
(12) Patent Application Publication
(10) Pub. No.: US 2024/0080157 A1
(43) Pub. Date: Mar. 7, 2024

(54) APPARATUSES AND METHODS FOR FACILITATING QCL SOURCE REFERENCE SIGNAL RECEPTION IN BEAM BASED UNLICENCED OPERATION

(71) Applicant: Nokia Technologies Oy, Espoo (FI)

(72) Inventors: Sami-Jukka HAKOLA, Kempele (FI); Karol SCHOBER, Helsinki (FI)

(21) Appl. No.: 18/262,481

(22) PCT Filed: Dec. 13, 2021
(86) PCT No.: PCT/EP2021/085417

§ 371 Date: Jul. 21, 2023

(30) Foreign Application Priority Data
Jan. 25, 2021 (FI) 20215079

(51) Int. Cl. H04L 5/00

(52) U.S. Cl. CPC H04L 5/005; H04L 5/0092

(57) ABSTRACT

Example embodiments provide a procedure to improve reception of an aperiodic tracking reference signal by a client node, for example, when a periodic tracking reference signal was prevented. The aperiodic tracking reference signal resource may be dynamically associated with the periodic tracking reference signal through a provided synchronization signal block index. Further, a group common physical downlink control channel may be configured to trigger a monitoring window for reception of the aperiodic reference signal in response to a failed transmission of the periodic tracking reference signal. Apparatuses, methods, and computer programs are disclosed.

### TECHNICAL FIELD

The present application generally relates to information technology. In particular, some example embodiments of the present application relate to facilitating QCL (quasi co-location) source reference signal reception, for example, in case transmission of a periodic tracking reference signal of certain beams is prevented.

### BACKGROUND

Unlicensed or license-free spectrum may refer to a spectrum band that has predefined rules for both the hardware and deployment methods of the radio in such a manner that interference may be mitigated. Systems operating in unlicensed band are typically governed to implement a fair spectrum sharing mechanism such as listen-before-talk (LBT). LBT is adopted widely as the mechanism especially under 7 GHz carrier frequencies for unlicensed or shared spectrum operation where access nodes (like gNB in new radio, NR) may operate with sector wide beams and user nodes with omni-directional beams. According to the LBT procedure, the transmitter (e.g. the gNB or user node) in unlicensed spectrum may need to listen on the carrier before it starts to transmit. If the medium is free, the transmitter may transmit. If the medium is busy, e.g., some other node is transmitting, the transmitter may not transmit at the time. Therefore, the LBT procedure enables a clear channel assessment (CCA) check before using the channel. The LBT procedure may also be called a channel carrier sense multiple access (CSMA) scheme, channel assessment scheme, or clear channel assessment scheme. If the channel is found to be clear, then LBT is considered to be successful. If the channel is found to be busy, the LBT is considered to have failed (LBT failure/negative LBT). The LBT failure may require the gNB not to transmit signals in the same and/or subsequent subframes.

Beam based operation is based on beam management procedures to setup and maintain one or multiple beam pair links between the access node and the user node. In general, beam management may rely heavily on periodic signals, more specifically on periodic tracking reference signals (P-TRS), as QCL source for DL (downlink) signals and channels. However, channel access mechanism, i.e. LBT, may prevent transmission of P-TRS. The P-TRS may be the main QCL source for different signals and channels. Therefore, the user node may not have up to date QLC source for coming signals and/or channels to be received.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

Example embodiments may enable improving both downlink and uplink performance of a system by efficiently providing reference signals for tracking to client nodes in case transmission of a periodic reference signal for tracking was prevented. According to an embodiment, an aperiodic tracking reference signal (A-IRS) resource may be assigned dynamically for a periodic tracking reference signal (P-TRS) through a provided SSB index. The procedure may further comprise triggering a A-TRS monitoring window based on a group common physical downlink control channel (GC-PDCCH). Hence, a beam specific transmission of the A-TRS may be triggered to one or a plurality of client nodes at a time. The A-TRS monitoring window may be dependent on whether transmission of a P-TRS was validated or not. This may be achieved by the features of the independent claims. Further implementation forms are provided in the dependent claims, the description, and the drawings.

According to a first aspect, an apparatus may comprise at least one processor; and at least one memory including computer program code; the at least one memory and the computer code configured to, with the at least one processor, cause the apparatus at least to obtain a configuration of at least one periodic tracking reference signal resource set; obtain a configuration of one or more aperiodic tracking reference signal resource set; and obtain a configuration of a group common physical downlink control channel and a monitoring window for reception of an aperiodic tracking reference signal triggering command through the group common physical downlink control channel; determine failed reception of at least one periodic tracking reference signal; monitor the group common physical downlink control channel to receive the aperiodic tracking reference signal triggering command within the monitoring window in response to the failed reception; obtain an index to at least one of the one or more aperiodic tracking reference signal resource set and at least one associated index to a synchronization signal block based on the aperiodic tracking reference signal trigger command to determine parameters for reception of at least one aperiodic tracking reference signal; and receive the at least one aperiodic tracking reference signal based on the parameters.

According to an example embodiment of the first aspect, the parameters may comprise at least one of a frequency domain allocation in relation to a common resource grid of a network node, a time domain allocation, symbol positions in a slot, a quasi-co location assumption associated with the at least one periodic tracking reference signal with failed reception based on the synchronization signal block index.

According to an example embodiment of the first aspect, the triggering command may comprise an indication of a time interval between the triggering command and the slot wherein the at least one aperiodic tracking reference signal is transmitted.

According to an example embodiment of the first aspect, the quasi co-location assumption may comprise at least one of a quasi-co location TypeC or TypeD reference signal.

According to an example embodiment of the first aspect, the configuration of the monitoring window may comprise at least one of a number of slots indicating a length of the monitoring window, an indication of a time offset to a start of the monitoring window after the failed reception of the at least one periodic tracking reference signal or a periodicity of the monitoring window.

According to an example embodiment of the first aspect, the at least one memory and the computer code may be further configured to, with the at least one processor, cause the apparatus to determine at least one quasi co-location assumption for reception of the group common physical downlink control channel based on the at least one quasi co-location assumption of the at least one periodic tracking reference signal with failed reception.

According to an example embodiment of the first aspect, the quasi co-location assumption may comprise an indication of at least one of an average delay, doppler shift or a spatial reception parameter.

According to an example embodiment of the first aspect, reception of the at least one periodic tracking reference signal may be determined as failed based on blind detection of the periodic tracking reference signal.

According to an example embodiment of the first aspect, the reception of the at least one periodic tracking reference signals may be determined as failed based on unsuccessful validation of transmission of the periodic tracking reference signal.

According to an example embodiment of the first aspect, reception of the aperiodic tracking reference signal triggering command may be detected based on a radio network temporary identifier.

According to a second aspect, an apparatus may comprise at least one processor; and at least one memory including computer program code; the at least one memory and the computer code configured to, with the at least one processor, cause the apparatus at least to transmit a configuration of at least one periodic tracking reference signal resource set to at least one client node; transmit a configuration of one or more aperiodic tracking reference signal resource sets to the at least one client node; transmit a configuration of a group common physical downlink control channel and a monitoring window for transmission of an aperiodic tracking reference signal triggering command by the apparatus to the at least one client node; transmit the aperiodic tracking reference signal triggering command to the at least one client node for reception of at least one aperiodic tracking reference signal in response to a failed transmission of at least one periodic tracking reference signal by the apparatus, the trigger command comprising an indication of an index to at least one of the one or more aperiodic tracking reference signal resource sets and an index to at least one associated synchronization signal block; and transmit the at least one aperiodic tracking reference signal for the at least one client node.

According to an example embodiment of the second aspect, the aperiodic tracking reference signal triggering command may further comprise an indication of a time interval between the triggering command and a slot for transmission of the at least one aperiodic tracking reference signal.

According to an example embodiment of the second aspect, the configuration of the monitoring window may comprise at least one of a number of slots indicating a length of the monitoring window, a time offset indicating a start time of the monitoring window after the failed transmission of the at least one periodic tracking reference signal or a periodicity of the monitoring window.

According to an example embodiment of the second aspect, the index of the at least one synchronization signal block may be further associated to quasi co-location assumption of the at least one periodic tracking reference signal. The quasi co-location assumption may comprise, for example, an indication of at least one of an average delay, doppler shift or a spatial Rx parameter.

According to a third aspect, a method may comprise obtaining a configuration of at least one periodic tracking reference signal resource set; obtaining a configuration of one or more aperiodic tracking reference signal resource set; obtaining a configuration of a group common physical downlink control channel and a monitoring window for reception of an aperiodic tracking reference signal triggering command through the group common physical downlink control channel; determining failed reception of at least one periodic tracking reference signal; monitoring the group common physical downlink control channel to receive the aperiodic tracking reference signal triggering command within the monitoring window in response to the failed reception; obtaining an index to at least one of the one or more aperiodic tracking reference signal resource set and at least one associated index to a synchronization signal block based on the received aperiodic tracking reference signal trigger command to determine parameters for reception of at least one aperiodic tracking reference signal; and receiving the at least one aperiodic tracking reference signal based on the parameters.

According to an example embodiment of the third aspect, the parameters may comprise at least one of a frequency domain allocation in relation to a common resource grid of a network node, a time domain allocation, symbol positions in a slot, a quasi-co location assumption associated with the at least one periodic tracking reference signal with failed reception based on the synchronization signal block index.

According to an example embodiment of the third aspect, the triggering command may comprise an indication of a time interval between the triggering command and the slot wherein the at least one aperiodic tracking reference signal is transmitted.

According to an example embodiment of the third aspect, the quasi co-location assumption may comprise at least one of a quasi-co location TypeC or TypeD reference signal.

According to an example embodiment of the third aspect, the configuration of the monitoring window may comprises at least one of a number of slots indicating a length of the monitoring window, an indication of a time offset to a start of the monitoring window after the failed reception of the at least one periodic tracking reference signal or a periodicity of the monitoring window.

According to an example embodiment of the third aspect, the method may further comprise determining at least one quasi co-location assumption for reception of the group common physical downlink control channel based on the at least one quasi co-location assumption of the at least one periodic tracking reference signal with failed reception.

According to an example embodiment of the third aspect, the quasi co-location assumption may comprise an indication of at least one of an average delay, doppler shift or a spatial Rx parameter.

According to an example embodiment of the third aspect, reception of the at least one periodic tracking reference signal may be determined as failed based on blind decoding of the periodic tracking reference signal.

According to an example embodiment of the third aspect, reception of the at least one periodic tracking reference signals may be determined as failed based on unsuccessful validation of transmission of the periodic tracking reference signal.

According to an example embodiment of the third aspect, reception of the aperiodic tracking reference signal triggering command may be detected based on a radio network temporary identifier.

According to a fourth aspect, a method may comprise transmitting a configuration of at least one periodic tracking reference signal resource set to at least one client node; transmitting a configuration of one or more aperiodic tracking reference signal resource sets to the at least one client node; transmitting a configuration of a group common physical downlink control channel and a monitoring window for transmission of an aperiodic tracking reference signal triggering command by the apparatus to the at least one client node; transmitting the aperiodic tracking reference signal triggering command to the at least one client node for reception of at least one aperiodic tracking reference signal in response to a failed transmission of at least one periodic tracking reference signal by the apparatus, the trigger command comprising an indication of an index to at least one of the one or more aperiodic tracking reference signal resource sets and an index to at least one associated synchronization signal block; and transmitting the at least one aperiodic tracking reference signal for the at least one client node.

According to an example embodiment of the fourth aspect, the aperiodic tracking reference signal triggering command further comprises an indication of a time interval between the triggering command and a slot for transmission of the at least one aperiodic tracking reference signal.

According to an example embodiment of the fourth aspect, the configuration of the monitoring window comprises at least one of a number of slots indicating a length of the monitoring window, a time offset indicating a start time of the monitoring window after the failed transmission of the at least one periodic tracking reference signal or a periodicity of the monitoring window.

According to an example embodiment of the fourth aspect, the index of the at least one synchronization signal block may be further associated to quasi co-location assumption of the at least one periodic tracking reference signal. The quasi co-location assumption may comprise, for example, an indication of at least one of an average delay, doppler shift or a spatial Rx parameter.

According to a fifth aspect, a computer program may be configured, when executed by a processor, to cause an apparatus at least to perform the method according to the third aspect.

According to a sixth aspect, an apparatus may comprise means for obtaining a configuration of at least one periodic tracking reference signal resource set; means for obtaining a configuration of one or more aperiodic tracking reference signal resource set; means for obtaining a configuration of a group common physical downlink control channel and a monitoring window for reception of an aperiodic tracking reference signal triggering command through the group common physical downlink control channel; means for determining failed reception of at least one periodic tracking reference signal; means for monitoring the group common physical downlink control channel to receive the aperiodic tracking reference signal triggering command within the monitoring window in response to the failed reception; means for obtaining an index to at least one of the one or more aperiodic tracking reference signal resource set and at least one associated index to a synchronization signal block based on the received aperiodic tracking reference signal trigger command to determine parameters for reception of at least one aperiodic tracking reference signal; and means for receiving the at least one aperiodic tracking reference signal based on the parameters. The apparatus may further comprise means for performing any example embodiment of the method of the third aspect.

According to a seventh aspect, a computer program may comprise instructions for causing an apparatus to perform the method according to the fourth aspect.

According to an eighth aspect, an apparatus may comprise means for transmitting a configuration of at least one periodic tracking reference signal resource set to at least one client node; means for transmitting a configuration of one or more aperiodic tracking reference signal resource sets to the at least one client node; means for transmitting a configuration of a group common physical downlink control channel and a monitoring window for transmission of an aperiodic tracking reference signal triggering command by the apparatus to the at least one client node; means for transmitting the aperiodic tracking reference signal triggering command to the at least one client node for reception of at least one aperiodic tracking reference signal in response to a failed transmission of at least one periodic tracking reference signal by the apparatus, the trigger command comprising an indication of an index to at least one of the one or more aperiodic tracking reference signal resource sets and an index to at least one associated synchronization signal block; and means for transmitting the at least one aperiodic tracking reference signal for the at least one client node. The apparatus may further comprise means for performing any example embodiment of the method of the fourth aspect.

Many of the attendant features will be more readily appreciated as they become better understood by reference to the following detailed description considered in connection with the accompanying drawings.

### DESCRIPTION OF THE DRAWINGS

The accompanying drawings, which are included to provide a further understanding of the example embodiments and constitute a part of this specification, illustrate example embodiments and together with the description help to explain the example embodiments. In the drawings:

FIG. 1 illustrates an example of a communication network comprising a network node and a client node according to an example embodiment;

FIG. 2 illustrates an example of a procedure for receiving an A-TRS by a client node after failed detection of a P-TRS, according to an example embodiment.

FIG. 3 illustrates an example of a method for QCL source reference signal reception by a client node, according to an example embodiment;

FIG. 4 illustrates an example of a method for facilitating QCL source reference signal reception for at least one client node by a network node, according to an example embodiment;

FIG. 5 illustrates an example of a message sequence chart for facilitating QCL source reference signal reception of at least one client node from a network node, according to an example embodiment;

FIG. 6 illustrates an example of an apparatus configured to practice one or more example embodiments;

Like references are used to designate like parts in the accompanying drawings.

### DETAILED DESCRIPTION

Reference will now be made in detail to example embodiments, examples of which are illustrated in the accompanying drawings. The detailed description provided below in connection with the appended drawings is intended as a description of the present examples and is not intended to represent the only forms in which the present examples may be constructed or utilized. The description sets forth the functions of the example and a possible sequence of operations for constructing and operating the example. However, the same or equivalent functions and sequences may be accomplished by different examples.

Beam management (BM) procedures developed for FR2 (carrier frequency range between 24 and 52.6 GHz) may provide a good baseline for NR operation above 52.6 GHz, and thus also for unlicensed operation at 60 GHz. Procedures for downlink beam management called P-1, P-2 and P-3 may provide a set of functionalities for beam search, beam indication, and beam refinement at gNB and UE (user equipment) within one or multiple TRPs (transmission-reception points).

P-1 may be used to enable UE measurement on different TRP Tx (transmission) beams to support selection of TRP Tx beams and/or UE Rx (reception) beam(s). For beamforming at TRP, the procedure may include an intra/inter-TRP Tx beam sweep from a set of different beams. For beamforming at UE, the procedure may include a UE Rx beam sweep from a set of different beams.

P-2 may be used to enable UE measurement on different TRP Tx beams to possibly change inter/intra-TRP Tx beam(s), for example, from a possibly smaller set of beams for beam refinement than in P-1. P-2 may be a special case of P-1.

P-3 may be used to enable UE measurement on the same TRP Tx beam to change UE Rx beam in case UE uses beamforming.

As mentioned above, BM may rely on the periodic tracking reference signals (P-TRS) as QCL source for DL signals and channels. Furthermore, beam failure detection reference signal (RS) and candidate RSs for new beam identification in beam failure recovery procedure may need to be periodic, and typically failure detection RSs are P-TRSs because of being active QCL sources for PDCCH monitoring in control resource sets (CORESETs). Based on QCL source(s) RS, UE may prepare channel estimation filters (time and frequency domain estimates like delay spread and doppler spread) and sets its RX beam for coming target signals. In typical deployment, the same periodic RSs may be used as spatial source for uplink signals and channels, i.e. DL reference signals based on which the UE forms the transmit beam(s) for uplink transmissions. A QCL configuration for downlink signals and channels may comprise, for example, P-TRS as the source and CSI-RS for beam management, PDCCH, PDSCH and/or A-TRS as a target. Further, SSB may be a QCL source for the P-TRS and the A-TRS for the CSI-RS/PDCCH/PDSCH.

Channel access mechanism, such as LBT, may prevent transmission of the P-TRS. Because UE may not therefore have up to date QCL source for coming signals/channels to be received, the downlink performance as well as the uplink performance may be negatively impacted. To avoid this, the gNB may trigger aperiodic TRS configured for the UE. The A-TRS may be associated to P-TRS, wherein the A-TRS comprises the same QCL assumptions as the associated P-TRS. In other words, P-TRS may be configured in order to be able to trigger A-TRS. However, especially at higher carrier frequencies, even if the A-TRS was self-dependent, UE-specific A-TRS triggering may generate large PDCCH (physical downlink control channel) overhead when multiple UEs are in connected mode and each UE is triggered by A-TRS separately. Furthermore, triggering the A-TRS may be of concern to the gNB which may be limited in terms of beam resources at the higher carrier frequencies.

In a cycling SSB (synchronization signal block) transmission scheme, for an SSB of a certain index there may be additional positions that can be used for the transmission of the SSB of the certain index if the LBT failure happened for the first position. For example, for different number of beams in use in the cell, SSB block candidate locations within 10 slots may be provided. Furthermore, also P-TRS may be allocated around SSB and utilize the same cycling pattern for TRS in order to survive from negative LBTs. However, the problem with the approach is that inter-distance between TRS symbols may need to be changed from existing one defined in NR. Hence, change in UE implementation could be required. However, modern algorithms are designed and optimized based on existing TRS structure and the change would result into a lot of implementation complexity which may not be acceptable from UE vendors point of view.

Two types of DRS (discovery reference signal comprising SSB) transmission configurations/patterns may be used to improve chances for transmitting DRS more regularly in unlicensed spectrum. Second DRS transmission configuration may be for the transmission of DRS in case of LBT prevents transmitting according to the first DRS transmission configuration. However, the procedure fails to consider the problem related to TRS transmission and reception at the UE.

Different group common PDCCHs (GC-PDCCH) i.e. downlink control information (DCIs) that can be intended for more than one UE may be supported. From UE perspective these are just DCI formats that are scrambled with certain DCI where the part of the payload is intended for the UE. In other words, only a sub-set of the full DCI information bits may be indicated to contain information specifically for a given UE.

Examples of GC-PDCCH may comprise a slot format indication (DCI format 2-0 scrambled by slot format indication radio network temporary identifier, SFI-RNTI) used to signal the dynamic slot format for the UE(s), a pre-emption indication (DCI format 2_1 scrambled by interruption RNTI for DL in Rel-15 and DCI format 2_4 scrambled by CI-RNTI in Rel-16 (cell indication, CI)) to inform UE that preceding transmission on certain DL resources was not done as intended/scheduled or that scheduled UL (uplink) transmission should not be done. In addition, UL power control commands for PUCCH, PUSCH and SRS may be provided in GC-PDCCHs (DCI format 2_2 and 2_3). A GC-PDCCH DCI format may be provided for power saving purposes (DCI format 2_6 scrambled by PS-RNTI (power saving RNTI)). DCI format 2_0 content may be extended with channel-occupancy-duration, search-space switching bit, and resource block set, RB-set, indicator for NR-Unlicensed operation.

According to an example embodiment, a procedure enhancing adaption to LBT failures may be provided. A GC-PDCCH triggered aperiodic TRS transmission and reception method is provided where a network node, such as gNB, may trigger a beam specific transmission of aperiodic TRS to one or multiple client nodes, such as UEs, at a time. The A-TRS may be triggered, for example, when the LBT failure has prevented transmission of periodic TRS of certain beam(s). In an embodiment, the A-TRS and P-TRS may be dynamically connected to each other through a provided SSB index. The SSB index may be provided by the A-TRS trigger.

Advantage of example embodiments may comprise providing TRS for the UEs in efficient manner. The gNB may be able to provide the same P-TRS configurations for multiple UEs. In addition, the gNB may be able to trigger the A-TRS for the multiple UEs with a single trigger saving lots of PDCCH resources as well as beam resources. Hence, both downlink and uplink performance may be improved in the system while keeping PDCCH overhead from the triggering low.

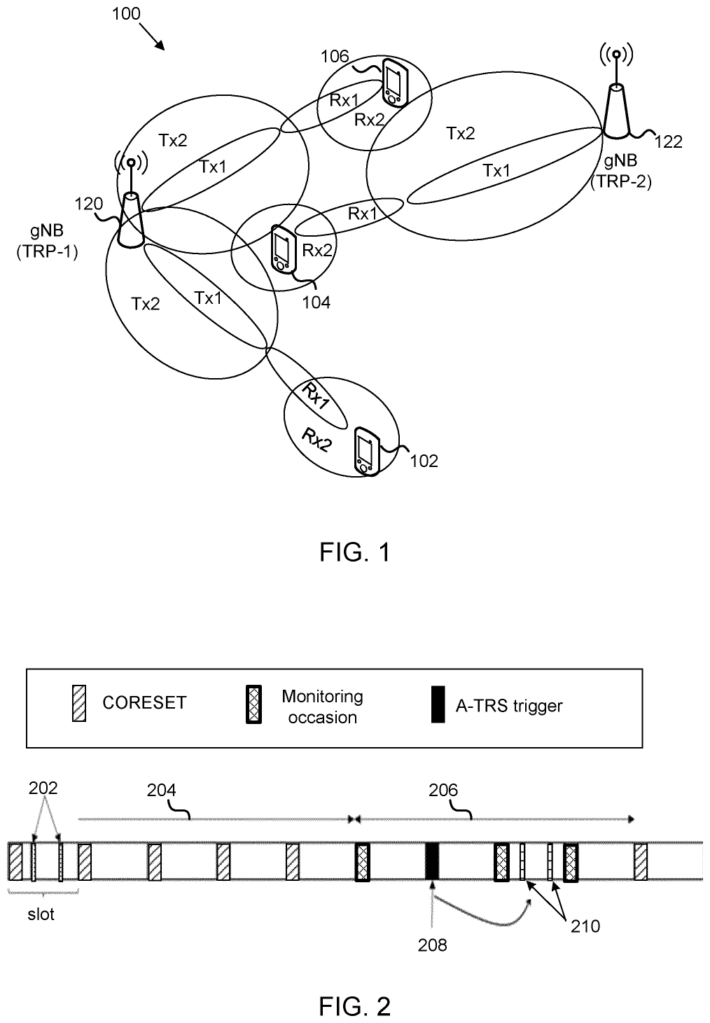

FIG. 1 illustrates an example of a communication network 100 comprising a network node and a client node. The communication network 100 may comprise one or more base stations, such as 5G nodes, gNBs 120, 122, and/or 4G nodes, eNBs. The first gNB 120 may be also called a first transmission reception point (TRP-1). The second gNB 122 may be also called a second transmission reception point (TRP-2). The communication network 100 may further comprise one or more client nodes, which may be also referred to as a user nodes or UEs 102, 104, 106. The UEs 102, 104, 106 may communicate with one or more of the base stations via wireless radio channel(s). Communications between UE 102, 104, 106, gNB 120, and gNB 122 may be bidirectional. Hence, any of the devices may be configured to operate as a transmitter and/or a receiver.

The communication network 100 may comprise one or more core network elements such as for example access and mobility management function (AMF) and/or user plane function (UPF). The base stations may be configured to communicate with the core network elements over a communication interface, such as for example a control plane interface or a user plane interface NG-C/U. Base stations may be also called radio access network (RAN) nodes and they may be part of a radio access network between the core network and the UEs. Network elements AMF/UPF and gNB may be generally referred to as network nodes or network devices. Although depicted as a single device, a network node may not be a stand-alone device, but for example a distributed computing system coupled to a remote radio head.

The communication network 100 may be configured for example in accordance with the 5th Generation digital cellular communication network, as defined by the 3rd Generation Partnership Project (3GPP). In one example, the communication network 100 may operate according to 3GPP 5G-NR. It is however appreciated that example embodiments presented herein are not limited to this example network and may be applied in any present or future wireless or wired communication networks, or combinations thereof, for example other type of cellular networks, short-range wireless networks, broadcast or multicast networks, or the like.

In general, the gNB 120, 122 and UE 102, 104, 106 may be configured to communicate at carrier frequencies where gNB and UE operate using more narrow RF radiation patterns than sector wide and omnidirectional patterns, respectively. In particular, the gNB 120, 122 and UE 102, 104, 106 may be configured for unlicensed operation targeting frequency range above 52.6 GHz. Other applicable frequency ranges may comprise, for example, frequency range 2 (FR2 24-52.6 GHz) and an upper part of below 7 GHz carrier frequency range. 60 GHz unlicensed band (57-71 GHz) may be the only IMT (international mobile telecommunications) band at above 52.6 GHz available in the near future. 9 GHz of spectrum in Europe and 14 GHz in the USA provides 10× (in Europe) and 16× (in the USA) as much unlicensed spectrum as is available currently in sub 7 GHz.

The number of antenna elements which may be used at the gNB 120, 122, may be determined based on regulations provided by ETSI (European Telecommunications Standards Institute), wherein regulated TX (transmission) power and EIRP (effective isotropic radiated power) are 27 dBm and 40 dBm, respectively. The rather limited EIRP (40 dBm) may cause a relatively small array in terms of the number of antenna elements, which is cost and power efficient. For example, assuming a CMOS power amplifier (PA) technology, an 8×4 element array may be used. For reference, a WiGiG (a set of 60 GHz wireless network protocols known also as 60 GHz Wi-Fi) uses typically an 4×4 array. Consequence of such a small or modest array size (in terms of antenna elements) is that the antenna radiation patterns, i.e. beams, are relatively wide. In other words, narrow or pencil beams may not be used. For instance, for 8×4 array the 3 dB beam widths are around 12.5 and 25 degrees in azimuth and elevation domain, respectively.

On the other hand, at mmwaves where the nodes may operate with very narrow beams there may not be need for LBT type mechanism because the likelihood for collision would be very low. The consideration is illustrated in high level in FIG. 1 where narrow TX1 and RX1 beams of the communicating nodes suppress the interference in spatial domain in efficient manner.

However, as discussed above, due to relatively low maximum allowed EIRP as well as due to targeting cost and power efficient transceiver and antenna architectures, relatively small array sizes may be used in practice at 60 GHz unlicensed operation. Therefore, the operation described above would change more towards illustration of TX2 and RX2 beams in FIG. 1. It can be observed from the FIG. 1 that likelihood for inter-beam interference or collisions increases with the wider beams. Consequently, there is need for a fair spectrum sharing channel access mechanism.

Based on above, LBT may be one of the main channel access methods also at mmWave unlicensed operation. The LBT type channel access mechanism may be adopted for 60 GHz unlicensed operation, at least in the scenarios where the low maximum allowed EIRPs are in use like CEPT c1 (indoor access) and c2 (indoor and outdoor access) that allow at maximum 40 dBm EIRP with 23 dBm/MHz PSD (power spectral density). The LBT may, however, prevent transmission of periodic TRS, since the periodic TRS are transmitted in pre-configured time instances.

FIG. 2 illustrates an example of a procedure for receiving an A-TRS by a client node after failed detection of a P-TRS, according to an example embodiment. The client node may be, for example, the UE 102, 104, 106. In FIG. 2, the client node may have not detected the P-TRS at transmission allocations 202 from the network, such as from the gNB 120, 122. The transmission allocations for reception of the P-TRS may be determined based on a P-TRS configuration.

In an embodiment, the network node and the client node may be configured for GC-PDCCH triggered aperiodic TRS transmission and reception. The network node may be configured to trigger a beam specific transmission of aperiodic TRS to the client node. Alternatively, the network node may trigger the beam specific transmission of the aperiodic TRS to a group of client nodes at a same time.

According to an example embodiment, at least one A-TRS resource set for tracking is provided. In an embodiment, the A-TRS resource set may comprise CSI-RS (channel state information reference signal) resource set for tracking. The client node may be configured for the at least one A-TRS resource. The information associated with the A-TRS may be configured, for example, in system information or via dedicated signaling (e.g. with ‘trs-info’). The A-TRS resource sets may not be associated priori to any periodic TRS resource set, i.e. they may be stand-alone sets. The A-TRS resource sets may not be provided with QCL source reference signals in higher layer configuration. In other words, resource connection to a particular P-TRS may not be configured for the A-TRS resource set.

In an embodiment, the client node may be provided with an RNTI (radio network temporary identifier), e.g. A-TRS-RNTI or SFI-RNTI, for detecting a A-TRS trigger command 208. The A-TRS trigger command 208 may be obtained from the GC-PDCCH in DCI received from the network node.

In an embodiment, the A-TRS triggering command 208 may be configured to provide the client node with an index to the at least one pre-configured A-TRS resource set for tracking configurations. The configuration may provide at least a frequency domain allocation, comprising a starting position and bandwidth, in relation to a common resource grid of the serving cell, symbol positions in the slot, etc. In an embodiment, multiple configurations may be used to trigger multiple A-TRSs transmitted with different TX beams of the network node. GC-PDCCH field may comprise, for example, at least one of a start position in DCI for UE-specific information, 1 bit per configured resource indicating triggering and/or 6-bits per configured resource to carry the SSB-indicator. The GC-PDCCH field may be compressed.

In an embodiment, the A-TRS triggering command 208 may be configured to provide the client node a time interval between the triggering command 208 and the slot the A-TRS resource set transmission 210 takes place.

In an embodiment, the A-TRS triggering command 208 may be configured to provide the client node an index to at least one SSB index. The SSB index may be applied for the corresponding reception of the triggered A-TRS resource set. Hence, the SSB index may dynamically connect the triggered A-TRS resource to a P-TRS through the SSB index. There may be one-to-one mapping between the invoked A-TRS resource set index and the SSB index. Hence, QCL assumptions associated with the P-TRS may be dynamically provided for the reception of the aperiodic TRS, such as QCL-TypeC and QCL-TypeD reference signal. The QLC-TypeC reference signal may comprise assumptions associated to an average delay and doppler shift. The QLC-TypeD reference signal may comprise assumptions associated to spatial Rx parameters.

According to an embodiment, the client node may be configured to monitor the GC-PDCCH comprising A-TRS-RNTI carrying the A-TRS trigger command 208. A monitoring window 206 may be defined for the monitoring of the GC-PDCCH, for example, with A-TRS-RNTI or SFI-RNTI. A length of the monitoring window 206 may be determined by a number of slots. This may enable providing scheduling flexibility for the network node. Hence, the network node may be able to transmit the A-TRS when it determines the transmission medium to be free.

A location in time of the monitoring window 206 may be determined based on a configured time offset 204. In an embodiment, the time offset 204 may be calculated based on a certain radio frame boundary, e.g. mod(SFN, periodicity)=0. In an embodiment, in addition or alternatively, the time offset 204 may be calculated based on the slot in which periodic TRS is configured to be transmitted. The time offset 206 may be determined by the client node based on the obtained monitoring window configuration.

In an embodiment, the monitoring window 206 may have a configured periodicity. The monitoring periodicity may be associated to configured periodicity of the periodic TRS. The monitoring window 206 may comprise a plurality of monitoring occasions for reception of the GC-PDCCH by the client node based on the CORESETs. The monitoring occasions may occur, for example, once a slot within the monitoring window 206.

In an embodiment, the client node may be configured to determine existence of the monitoring window 206 based on blind detection of the periodic TRS. Blind detection may refer e.g. to operation where the client node tries to detect a known TRS signal from the network node on certain resource (frequency and time) while the network node may or may not transmit the signal of interest. The blind detection may comprise blind decoding, wherein the client node tries to detect certain coded transmission from the network node from a set of candidate resources. In other words, the client node may monitor the set of resources (frequency and time) and try to detect and decode a message from the network node where the network node may use a subset of the resources or may not transmit at all. Successful detection may happen when the client node can decode correctly the transmitted message and/or when the client node determines that e.g. cyclic redundancy check code was correct when decoding the message.

Alternatively, the client node may be configured to determine existence of the monitoring window 206 based on validation. The validation may be based on, for example, receiving PDCCH/PDSCH to overlap with P-TRS resource or receiving an SFI or CO-duration (CO, channel occupancy) validating transmission of the P-TRS.

In an embodiment, if the client node validates the periodic TRS transmission in the latest occasion before the monitoring window 206, the client node may not be required to monitor for GC-PDCCH with A-TRS-RNTI (or SFI RNTI) in the consequent monitoring window 206. If the client node determines the P-TRS was not received based on the validation result, the client node may be configured to monitor for GC-PDCCH with the A-TRS-RNTI or SFI-RNTI in the consequent monitoring window 206.

As a new QCL assumption option, the client node may determine QCL assumptions for the reception of the GC-PDCCH to be the same as the client node assumed for the reception of the P-TRS which the client node determined as not being transmitted in the previous occasion. The new QCL assumption may comprise, for example, QCL-TypeD assumption to setup RX beam for the reception. Alternatively, QCL assumptions for the reception of GC-PDCCH may be provided via existing TCI (transmission configuration indicator) state activation procedure for the CORESET used for the GC-PDCCH transmission.

In an embodiment, the client node may be configured to determine the at least one triggered resource set configuration index and corresponding SSB index based on the triggering command upon detection of the GC-PDCCH with A-TRS-RNTI. In an embodiment, the client node may be configured to determine from the at least one SSB index the one(s) that are acting as at least one of QCL-TypeD and/or QCL-TypeC source for the P-TRS(s) the client node determined that were not transmitted. In an embodiment, the client node may be configured to receive the at least one A-TRS transmission corresponding to above determined at least one SSB index.

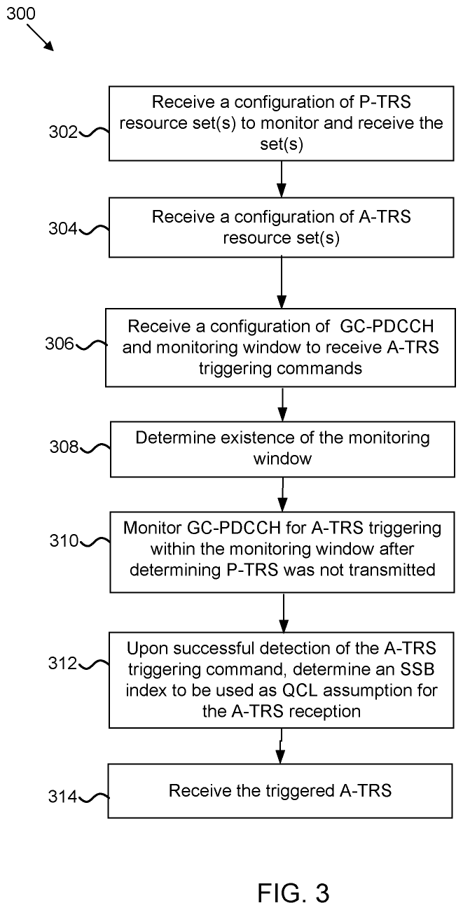

FIG. 3 illustrates an example of a method 300 for QCL source reference signal reception by a client node, according to an example embodiment. The procedure of FIG. 3 may be executed, for example, by the UE 102, 104, 106 as the client node.

At 302, a configuration of at least one P-TRS resource set to monitor and receive the P-TRS signals may be obtained.

At 304, a configuration of at least one A-TRS resource set may be received. The A-TRS resource set(s) may be stand-alone sets such that they may not be associated with any specific P-TRS resource set(s), e.g. with the same QCL assumptions.

At 306, a configuration of GC-PDCCH and monitoring window may be received to receive A-TRS triggering commands through the group common physical downlink control channel. The configuration may comprise, for example, indication of an identifier for detecting the A-TRS triggering command. The configuration may comprise parameters for triggering and defining characteristics of the monitoring window in response to the GC-PDCCH.

At 308, existence of the monitoring window may be determined. Existence of the monitoring window may be based on a failed transmission of P-TRS by a network node to the client node. In an embodiment, the existence of the monitoring window may be determined, for example, based on a blind detection of the periodic TRS. In an embodiment, the existence of the monitoring window may be determined, for example, based on validation, such as receiving PDCCH/PDSCH to overlap with P-TRS resource, or receiving an SFI or CO-duration validating transmission of P-TRS. If the P-TRS transmission is validated in the latest occasion before the monitoring window, monitoring for GC-PDCCH with A-TRS-RNTI or SFI-RNTI may not be required in a consequent monitoring window.

At 310, GC-PDCCH for A-TRS triggering within the monitoring window may be monitored based on the validation result at 308 indicating that P-TRS was not transmitted. In an embodiment, the client node may be configured to assume the same QCL-TypeD RS as spatial RX parameter as for the P-TRS reception if no other source has been provided for the GC-PDCCH reception.

Upon successful detection of the A-TRS triggering command, for example, from DCI received via the GC-PDCCH, at 312, an SSB index to be used as QCL assumption for the A-TRS reception may be determined. The QLC assumption may comprise, for example, TypeD RS assumption. In addition, other parameters from the DCI may be determined to enable reception of the A-TRS. The parameters may comprise, for example, a resource set indication, a time domain allocation, a frequency domain allocation, and the like.

At 314, the triggered A-TRS may be received based on the parameters obtained from the DCI.

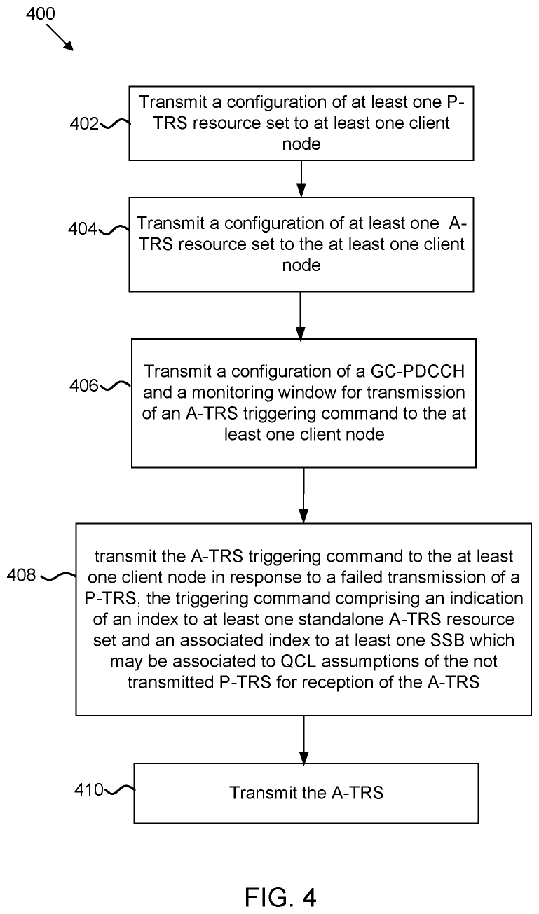

FIG. 4 illustrates an example of a method 400 for facilitating QCL source reference signal reception for at least one client node by a network node, according to an example embodiment. The procedure of FIG. 4 may be executed, for example, by the gNB 120, 122 as the network node.

At 402, a configuration of at least one P-TRS resource set may be transmitted to at least one client node.

At 404, a configuration of at least one A-TRS resource set may be transmitted to the at least one client node. The A-TRS resource set may not be associated to any specific P-TRS.

At 406, a configuration of a GC-PDCCH and a monitoring window for transmission of an A-TRS triggering command may be transmitted to the at least one client node. The configurations transmitted at 402, 404 and 406 may be determined by the network node.

At 408, the A-TRS triggering command may be transmitted to the at least one client node in response to a failed transmission of a P-TRS by the network node, the trigger command comprising an indication of an index to the at least one A-TRS resource set and an index to at least one SSB. The SSB may be associated to QLC assumptions of the not transmitted P-TRS for reception of the A-TRS. The index of a specific A-TRS resource sets and may be mapped to an index of a specific SSB.

At 410, the A-TRS may be transmitted by the network node.

Further features of the methods 300, 400 directly result from the functionalities and parameters of the apparatuses, such as the network nodes and the client nodes, as described in the appended claims and throughout the specification and are therefore not repeated here. It is noted that one or more operations of the method may be performed in different order.

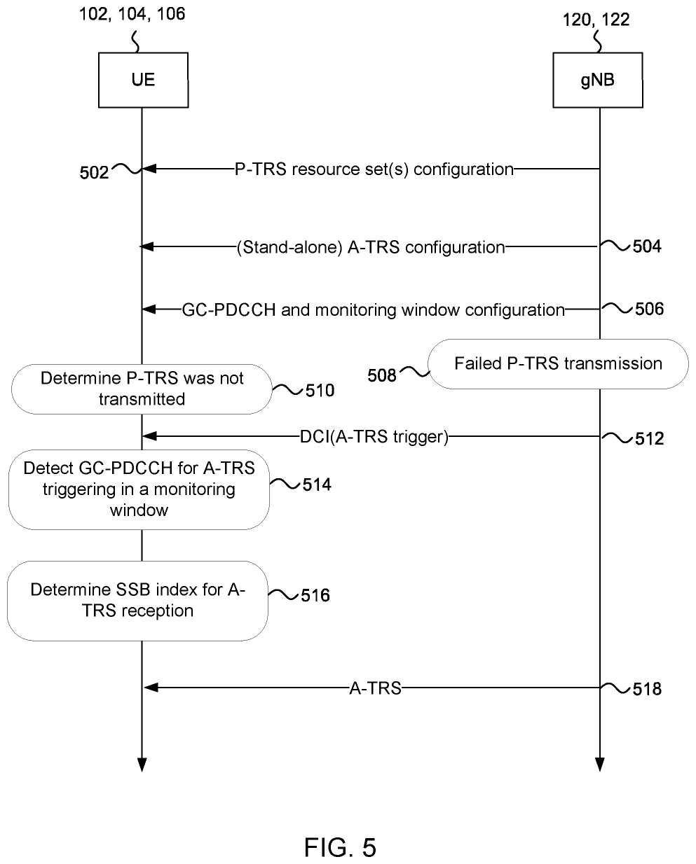

FIG. 5 illustrates an example of a message sequence chart for facilitating QCL source reference signal reception of at least one client node from a network node, according to an example embodiment. The client node may be, for example, the UE 102, 104, 106. The network node may be, for example, the gNB 120, 122.

The UE 102, 104, 106 may be configured to obtain, from the gNB 120, 122, configurations for at least one P-TRS resource set at 502. The UE 102, 104, 106 may be further configured to obtain, from the gNB 120, 122, configurations for at least one A-TRS resource set at 504. In an embodiment, the A-TRS resource set may not be associated to the P-TRS resource set but is a stand-alone resource set. At 506, the UE 102, 104, 106 may be further configured to obtain, from the gNB 120, 122, configurations of a GC-PDCCH and a monitoring window. Based on the configurations at 506, the UE 102, 104, 106 may be able to monitor within the monitoring window for the GC-PDCCH carrying a A-TRS triggering command from the gNB 120, 122.

At 508, transmission of at least one P-TRS may have failed from the gNB 120, 122. At 510, the UE 102, 104, 106 may determine the at least one P-TRS was not transmitted. In response, the UE 102, 104, 106 may monitor the reception of the GC-PDCCH triggering A-TRS. At 512, the UE 102, 104, 106 may receive DCI through the GC-PDCCH from the gNB 120, 122, which may comprise the A-TRS trigger. At 514, the UE 102, 104, 106 may detect the A-TRS trigger from the GC-PDDCH, for example, based on A-TRS-RNTI or SFI-RNTI. Based on the A-TRS triggering command, the UE 102, 104, 106 may be configured to determine at least one SSB index for the A-TRS reception at 516. The at least one SSB index may be associated to at least one of the pre-configured A-TRS resource sets and at least one QCL assumption dynamically linking the A-TRS with the P-TRS. At 518, the A-TRS may be received by the UE 102, 104, 106 from the gNB 120. Reception of the A-TRS may be enabled by the QCL assumption and other parameters obtained from the A-TRS trigger command.

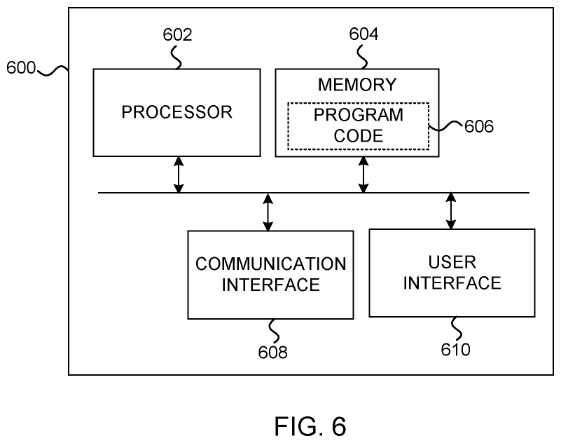

FIG. 6 illustrates an example of an apparatus 600 configured to practice one or more example embodiments.

The apparatus 600 may comprise at least one processor 602. The at least one processor 602 may comprise, for example, one or more of various processing devices, such as for example a co-processor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The apparatus 600 may further comprise at least one memory 604. The memory 604 may be configured to store, for example, computer program code 606 or the like, for example operating system software and application software. The memory 604 may comprise one or more volatile memory devices, one or more non-volatile memory devices, and/or a combination thereof. For example, the memory 604 may be embodied as magnetic storage devices (such as hard disk drives, magnetic tapes, etc.), optical magnetic storage devices, or semiconductor memories (such as mask ROM, PROM (programmable ROM), EPROM (erasable PROM), flash ROM, RAM (random access memory), etc.).

The apparatus 600 may further comprise one or more communication interfaces 608 configured to enable the apparatus 600 to transmit and/or receive information, to/from other apparatuses. The communication interface 608 may be configured to provide at least one wireless radio connection, such as for example a 3GPP mobile broadband connection (e.g. 3G, 4G, 5G). However, the communication interface 608 may be configured to provide one or more other type of connections, for example a wireless local area network (WLAN) connection such as for example standardized by IEEE 802.11 series or Wi-Fi alliance; a short range wireless network connection such as for example a Bluetooth, NFC (near-field communication), or RFID connection; a wired connection such as for example a local area network (LAN) connection, a universal serial bus (USB) connection or an optical network connection, or the like; or a wired Internet connection. The communication interface 608 may comprise, or be configured to be coupled to, at least one antenna to transmit and/or receive radio frequency signals. One or more of the various types of connections may be also implemented as separate communication interfaces, which may be coupled or configured to be coupled to a plurality of antennas.

The apparatus 600 may further comprise a user interface 610 comprising an input device and/or an output device. The input device may take various forms such a keyboard, a touch screen, or one or more embedded control buttons. The output device may for example comprise a display, a speaker, a vibration motor, or the like.

When the apparatus 600 is configured to implement some functionality, some component and/or components of the apparatus 600, such as for example the at least one processor 602 and/or the memory 604, may be configured to implement this functionality. Furthermore, when the at least one processor 602 is configured to implement some functionality, this functionality may be implemented using program code 606 comprised, for example, in the memory 604.

The functionality described herein may be performed, at least in part, by one or more computer program product components such as software components. According to an embodiment, the apparatus 600 comprises a processor 602 or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), application-specific Integrated Circuits (ASICs), application-specific Standard Products (ASSPs), System-on-a-chip systems (SOCs), Complex Programmable Logic Devices (CPLDs), Graphics Processing Units (CPUs).

The apparatus 600 comprises means for performing at least one method described herein. In one example, the means comprises the at least one processor 602, the at least one memory 604 including program code 606 configured to, when executed by the at least one processor 602, cause the apparatus 600 to perform the method.

The apparatus 600 may comprise for example a computing device such as for example a base station, a network node, a server device, a client node, a mobile phone, a tablet computer, a laptop, or the like. The apparatus 600 may comprise, for example, the gNB 120, 122 or the UE 102, 104, 106. Although the apparatus 600 is illustrated as a single device it is appreciated that, wherever applicable, functions of the apparatus 600 may be distributed to a plurality of devices.

Any range or device/apparatus value given herein may be extended or altered without losing the effect sought. Also, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The operations of the methods described herein may be carried out in any suitable order, or simultaneously where appropriate. Additionally, individual blocks may be deleted from any of the methods without departing from the scope of the subject matter described herein. Aspects of any of the embodiments described above may be combined with aspects of any of the other embodiments described to form further embodiments without losing the effect sought.

The term ‘comprising’ is used herein to mean including the method, blocks, or elements identified, but that such blocks or elements do not comprise an exclusive list and a method or apparatus may contain additional blocks or elements.

As used in this application, the term ‘circuitry’ may refer to one or more or all of the following: (a) hardware-only circuit implementations (such as implementations in only analog and/or digital circuitry) and (b) combinations of hardware circuits and software, such as (as applicable): (i) a combination of analog and/or digital hardware circuit(s) with software/firmware and (ii) any portions of hardware processor(s) with software (including digital signal processor(s)), software, and memory(ies) that work together to cause a device, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation. This definition of circuitry applies to all uses of this term in this application, including in any claims.

As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from scope of this specification.

1-15. (canceled)

16. An apparatus, comprising:
at least one processor; and
at least one memory including computer program code;
the at least one memory and the computer code configured to, with the at least one processor, cause the apparatus at least to:
obtain a configuration of at least one periodic tracking reference signal resource set;
obtain a configuration of one or more aperiodic tracking reference signal resource sets; and
obtain a configuration of a group common physical downlink control channel and a monitoring window for reception of an aperiodic tracking reference signal triggering command through the group common physical downlink control channel;
determine failed reception of at least one periodic tracking reference signal;
monitor the group common physical downlink control channel to receive the aperiodic tracking reference signal triggering command within the monitoring window in response to the failed reception;
obtain an index to at least one of the one or more aperiodic tracking reference signal resource sets and at least one associated index to a synchronization signal block based on the received aperiodic tracking reference signal trigger command to determine parameters for reception of at least one aperiodic tracking reference signal; and
receive the at least one aperiodic tracking reference signal based on the parameters.

17. The apparatus of claim 16, wherein the parameters comprise at least one of a frequency domain allocation in relation to a common resource grid of a network node, a time domain allocation, symbol positions in a slot, or a quasi-co location assumption associated with the at least one periodic tracking reference signal with failed reception based on the synchronization signal block index.

18. The apparatus of claim 16, wherein the triggering command comprises an indication of a time interval between the triggering command and the slot wherein the at least one aperiodic tracking reference signal is transmitted.

19. The apparatus of claim 16, wherein the configuration of the monitoring window comprises at least one of a number of slots indicating a length of the monitoring window, an indication of a time offset to a start of the monitoring window after the failed reception of the at least one periodic tracking reference signal or a periodicity of the monitoring window.

20. The apparatus of claim 16, wherein the at least one memory and the computer code are further configured to, with the at least one processor, cause the apparatus to:
determine at least one quasi co-location assumption for reception of the group common physical downlink control channel based on at least one quasi co-location assumption of the at least one periodic tracking reference signal with failed reception.

21. The apparatus of claim 16, wherein the parameters comprise at least one of a frequency domain allocation in relation to a common resource grid of a network node, a time domain allocation, symbol positions in a slot, or a quasi-co location assumption associated with the at least one periodic tracking reference signal with failed reception based on the synchronization signal block index, and wherein the quasi co-location assumption comprises an indication of at least one of an average delay, doppler shift or a spatial reception parameter.

22. The apparatus of claim 16, wherein the at least one memory and the computer code are further configured to, with the at least one processor, cause the apparatus to:
determine at least one quasi co-location assumption for reception of the group common physical downlink control channel based on at least one quasi co-location assumption of the at least one periodic tracking reference signal with failed reception, and wherein the quasi co-location assumption comprises an indication of at least one of an average delay, doppler shift or a spatial reception parameter.

23. The apparatus of claim 16, wherein reception of the at least one periodic tracking reference signal is determined as failed based on blind detection of the periodic tracking reference signal.

24. The apparatus of claim 16, wherein reception of the at least one periodic tracking reference signals is determined as failed based on unsuccessful validation of transmission of the periodic tracking reference signal.

25. The apparatus of claim 16, wherein reception of the aperiodic tracking reference signal triggering command is detected based on a radio network temporary identifier.

26. An apparatus, comprising:
at least one processor; and
at least one memory including computer program code;
the at least one memory and the computer code configured to, with the at least one processor, cause the apparatus at least to:
transmit a configuration of at least one periodic tracking reference signal resource set to at least one client node;
transmit a configuration of one or more aperiodic tracking reference signal resource sets to the at least one client node;
transmit a configuration of a group common physical downlink control channel and a monitoring window for transmission of an aperiodic tracking reference signal triggering command by the apparatus to the at least one client node;
transmit the aperiodic tracking reference signal triggering command to the at least one client node for reception of at least one aperiodic tracking reference signal in response to a failed transmission of at least one periodic tracking reference signal by the apparatus, the trigger command comprising an indication of an index to at least one of the one or more aperiodic tracking reference signal resource sets and an index to at least one associated synchronization signal block; and
transmit the at least one aperiodic tracking reference signal for the at least one client node.

27. The apparatus of claim 26, wherein the aperiodic tracking reference signal triggering command further comprises an indication of a time interval between the triggering command and a slot for transmission of the at least one aperiodic tracking reference signal.

28. The apparatus of claim 26, wherein the configuration of the monitoring window comprises at least one of a number of slots indicating a length of the monitoring window, a time offset indicating a start time of the monitoring window after the failed transmission of the at least one periodic tracking reference signal or a periodicity of the monitoring window.

29. The apparatus of claim 26, wherein the index of the at least one synchronization signal block is further associated to a quasi co-location assumption of the at least one periodic tracking reference signal.

30. A method, comprising:
obtaining a configuration of at least one periodic tracking reference signal resource set;
obtaining a configuration of one or more aperiodic tracking reference signal resource sets;
obtaining a configuration of a group common physical downlink control channel and a monitoring window for reception of an aperiodic tracking reference signal triggering command through the group common physical downlink control channel;
determining failed reception of at least one periodic tracking reference signal;
monitoring the group common physical downlink control channel to receive the aperiodic tracking reference signal triggering command within the monitoring window in response to the failed reception;
obtaining an index to at least one of the one or more aperiodic tracking reference signal resource sets and at least one associated index to synchronization signal block based on the aperiodic tracking reference signal trigger command to determine parameters for reception of at least one aperiodic tracking reference signal; and
receiving the at least one aperiodic tracking reference signal based on the parameters.

31. A method, comprising:
transmitting a configuration of at least one periodic tracking reference signal resource set to at least one client node;
transmitting a configuration of one or more aperiodic tracking reference signal resource sets to the at least one client node;
transmitting a configuration of a group common physical downlink control channel and a monitoring window for transmission of an aperiodic tracking reference signal triggering command by the apparatus to the at least one client node;
transmitting the aperiodic tracking reference signal triggering command to the at least one client node for reception of at least one aperiodic tracking reference signal in response to a failed transmission of at least one periodic tracking reference signal by the apparatus, the trigger command comprising an indication of an index to at least one of the one or more aperiodic tracking reference signal resource sets and an index to at least one associated synchronization signal block; and
transmitting the at least one aperiodic tracking reference signal for the at least one client node.
